(19) United States
(12) Patent Application Publication
(10) Pub. No.: US 2006/0171402 A1
(43) Pub. Date: Aug. 3, 2006

(54) Method and system for providing broadband multimedia services

(76) Inventors: John A. Moore, Carrollton, TX (US); Matthew N. Bowers, Dallas, TX (US); John P. Volpi, Garland, TX (US)

Correspondence Address: SLATER & MATSIL, L.L.P., 17950 PRESTON RD, SUITE 1000, DALLAS, TX, 75252-5793, US

(21) Appl. No.: 11/327,793

(22) Filed: Jan. 6, 2006

Related U.S. Application Data
(63) Continuation-in-part of application No. 10/794,507, filed on Mar. 5, 2004.
(60) Provisional application No. 60/452,371, filed on Mar. 6, 2003.
(60) Provisional application No. 60/642,073, filed on Jan. 7, 2005.

(51) Int. Cl. H04L 12/56; H04J 3/16

(52) U.S. Cl. 370/401; 370/466

(57) ABSTRACT

A services pivot point employable with first and second enterprises adapted to communicate over disparate access networks and a related method of operating the same. In one embodiment, the services pivot point includes a communication subsystem configured to provide a secure connection and data compression/acceleration for a communication between the client device and one of the first and second enterprises over the disparate access networks. The services pivot point also includes an authentication and profile subsystem configured to provide the client device access to one of the first and second enterprises over the disparate access networks based on policies associated with the client device.

This application is a continuation-in-part of U.S. patent application Ser. No. 10/794,507 entitled “Method and System for Providing Broadband Multimedia Services,” to Volpi, et al., filed Mar. 5, 2004, which claims benefit of U.S. Provisional Application No. 60/452,371 entitled “Method and System for Providing Broadband Multimedia Services,” filed Mar. 6, 2003, and also claims the benefit of U.S. Provisional Application No. 60/642,073 entitled “Method and System for Providing Broadband Multimedia Services,” filed Jan. 7, 2005, which applications are incorporated herein by reference.

### CROSS-REFERENCE TO RELATED APPLICATIONS

This application is related to U.S. patent application Ser. No. 10/197,065 entitled “System and Method for providing Requested Information to Thin Clients,” to Volpi, et al., with a priority date of Jul. 17, 2001, which application is hereby incorporated herein by reference.

### TECHNICAL FIELD

The present invention is directed, in general, to communication systems and, more specifically, to a multimedia system employable with a wireless network architecture.

### BACKGROUND

Historically, remote connectivity to enterprise internal business applications has been limited to narrowband dial-up modems across the public switched telephone network (“PSTN”). As a result, the available bandwidth is severely restricted, and the utility and desirability of using this access beyond very basic individual business applications are limited. There are now a variety of wired broadband access networks and a rapidly expanding variety of both narrowband and broadband wireless access networks. Business needs have also evolved rapidly as more members of the corporate world are working outside traditional office environments at the same time as the enterprise applications are becoming more important to the daily process of running the business.

The current methodology for delivering applications from an enterprise to its constituents (e.g., employees, contractors, suppliers) can be split into two fundamental offerings, namely, carrier centric offerings and enterprise centric offerings. The carrier centric offerings focus on selling an enterprise data services to deliver their applications over a wired or wireless network. At present, these offerings are limited to either the specific carrier's network or possibly networks of like protocol if such roaming relationships exist between operators. The enterprise centric offerings can be broken into two subsets, namely, enterprise middleware implementations and hosted enterprise middleware implementations. These services revolve around an application that is installed either at the enterprise or in a hosted environment that is dedicated to a specific enterprise that interacts with existing applications to optimize delivery over a specific network type such as a cellular network.

While current solutions work around some of the major issues, they still fail to meet all of the enterprise needs. The following provides some of the issues that should be addressed. The enterprise is experiencing a larger number of employees working outside of the office from a wider variety of locations, and more business processes depend on corporate databases. Also, the networks through which the remote access is delivered have become more varied in throughput and quality, and more access opportunities exist from wireless access on both a wide area basis and a localized basis. Additionally, the client communication devices or client devices (e.g., terminals) have and will continue to change rapidly from dedicated voice or data devices to true multimedia and computing platforms that can use multiple types of access networks employing disparate protocols.

In addition, extended enterprise sensor devices associated with a wide variety of corporate assets also should communicate through the access networks to enable critical business functions. As an example, information captured by sensors such as data flow through an oil and gas pipeline should be enabled to traverse access networks to facilitate energy supply metrics for a particular area, company, etc.

The networks also tend to be operated independently based on ownership with handover of communication content at standard lower layer interfaces which do not allow upper layer services control. The enterprises also send and receive communication content from their intranets and extranets through blocking gateways to protect their critical internal systems from malicious attacks. The enterprises have no visibility or control over the external networks, and their communication content passes through to the variety of access networks.

The aforementioned situations lead to less than optimal performance at all layers of the network and in all respects compared to a holistic end-to-end approach. What is needed in the art, therefore, is a system and method that delivers services and applications to client devices such as wireless devices that overcomes the deficiencies of the prior art and addresses the situations as mentioned above.

### SUMMARY OF THE INVENTION

To address the aforementioned limitations, the present invention provides a services pivot point employable with first and second enterprises adapted to communicate over disparate access networks and a related method of operating the same. In one embodiment, the services pivot point includes a communication subsystem configured to provide a secure connection and data compression/acceleration for a communication between the client device and one of the first and second enterprises over the disparate access networks. The services pivot point also includes an authentication and profile subsystem configured to provide the client device access to one of the first and second enterprises over the disparate access networks based on policies associated with the client device.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a diagram of an embodiment of an end-to-end network architecture demonstrating remote access to enterprise services and applications that provide an environment for an application of the principles of the present invention;

FIG. 2 illustrates a diagram of a high level overview of an embodiment of an end-to-end network architecture with an application delivery intermediary including a services pivot point in accordance with the principles of the present invention;

FIG. 3 illustrates a diagram of an embodiment of a services pivot point constructed in accordance with the principles of the present invention;

FIG. 4 illustrates a diagram of an embodiment of a services pivot point employing a distributed architecture in accordance with the principles of the present invention; and

FIGS. 5 to 7 illustrate diagrams of an embodiment of a general packet radio services roaming architecture, a general packet radio services transmission plane architecture and a general packet radio services roaming with the services pivot point as a home network or a multi-protocol mobile virtual network operator extension of the enterprise network, respectively, according to the principles of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The system and method of the present invention introduces an application delivery intermediary (“ADI”) that acts as a central provider of service wherein enterprises can securely connect to access a plurality of wireless and wired networks for carrying multimedia content to a variety of client devices such as remote access terminals and devices. The ADI is employable with a multitude of networks including, without limitation, global system for mobile communication (“GSM”), general packet radio services (“GPRS”), enhanced data GSM environment (“EDGE”), universal mobile telecommunications service (“UMTS”), code-division multiple access. (“CDMA”), evolution data only (“EVDO”), evolution data voice (“EVDV”), integrated digital enhanced network (“iDEN”), wireless fidelity (“Wi-Fi”), WiMAX, satellite communications (“SATCOM”), public switched telephone network (“PSTN”) and the Internet.

The ADI can be implemented in a variety of ways including as a primary service provider, secondary service provider or hybrid service provider. As a primary service provider, the ADI acts as a multi-protocol mobile virtual network operator (“MVNO”) whereby the entity has relationships with, for instance, a GSM network operator, a CDMA network operator, and a Wi-Fi network operator to provide efficient network access for an enterprise. Of course, any combination of mobile wireless, fixed wireless or wired networks may be employed in conjunction with acting as a primary service provider. The ADI acts as the “Home” network for the client devices. The client devices use the access networks of the roaming partner networks and the traffic is routed through a services pivot point associated with the ADI.

Acting as a secondary service provider, the ADI would not maintain MVNO relationships but would enter agreements with network operators to allow the passing of information between those networks and the ADI. Acting as a hybrid service provider, the ADI may enter into MVNO relationships with one or more network operators with the balance of the traffic being addressed through the previously mentioned information passing agreements.

The ADI may be embodied in a services pivot point (“SPP”) which generally has a peer network trusted arrangement with the many possible access networks and a peer network trusted arrangement with the enterprises (including the enterprise network(s)). A “peer trusted arrangement” implies access to the entire seven layers of the communication network [i.e., open systems interconnect (“OSI”) layers 1 through 7] in a non-encrypted environment. A single SPP may serve an entire network, but the SPP may be duplicated or implemented in a distributed manner. As information passes through the ADI, the SPP enables the evaluation and manipulation of the information as well as the implementation of value added services. The end-to-end performance of the desired communication channels can be evaluated in a way which matches the desired needs of the enterprise and the specific application and without requiring invasive changes to the multiple access network elements or enterprise network elements. Once in place, the SPP can act on all layers of the communications content to enable a host of improvements to the services and applications.

Due to the fact that the SPP provides exposure to the layers in the protocol stack (i.e., OSI layers 1 through 7) as the intermediary between the access networks and the enterprises, a significant number of managed service offerings are enabled. The managed service offerings can provide significant improvements over alternative carrier or enterprise centric implementations. In addition, this position enables the ADI to actively control, manage, and optimize a greater portion of the information chain between the enterprise and the client device.

The ADI can monitor and measure activity on the network for active adjustment through a variety of means and enhancements based on available alternative options, even for portions of the network not under the control of the ADI. One embodiment for evaluating alternative options over portions of the network not under the control of the ADI might be when a client device is a multi-mode terminal that has the ability to access the ADI through more than one network. The ADI will determine the preferred network and instruct the multi-mode user terminal on the appropriate network to use based on a set of performance criteria.

Due to the peer trusted arrangement, the ADI may manipulate the information traffic flowing in either direction therethrough. The manipulation enables the ADI to provide a variety of value added managed services to all of the enterprises on a shared basis. A sample of the services includes but is not limited to:

multi-level security including all forms of encryption, tunneling, and virtual private network (“VPN”),

virus and denial of service protection,

spam filtering,

user profile management,

presence management,

location based/location aware services,

packet level evaluation (e.g., for packet retransmit evaluation, billing, network monitoring and measurement),

compression optimization for specified delivery network,

content format optimization for varying customer terminals,

voice over packet over diverse network types,

electronic numbering (“ENUM”) management over diverse network types,

multimedia over packet over diverse network types,

protocol and content inter-network gateways,

groupware services including video conferencing and file or application sharing,

asynchronous delivery of content (i.e., push services),

personal information management (“PIM”), messaging services and synchronization,

delivery optimization of transit delay sensitive applications (i.e., multimedia video conferencing or interactive gaming),

content transcoding and caching,

telemetry services,

data backup and recovery services,

hosting of back office, productivity and communications applications (e.g., enterprise resource planning, customer relationship management, supply chain management applications, Microsoft Office, e-mail and instant messaging), and

application service provider (“ASP”) services akin to a hosted service provider.

For instance, a performance analyzer such as a packet analyzer may be deployed within the ADI that is focused on identifying packet retransmits being caused specifically within an access network(s) being used by an enterprise to deliver and receive information from a client device in order to reconcile usage and billing.

The system and method of the present invention will hereinafter be described with respect to preferred embodiments in a specific context, namely, the ADI in the environment of a communication network and related methods of delivering multimedia services. The principles of the present invention, however, may also be applied to other types of access points and controllers employable with network architectures. The advantages associated with the ADI further exploit the benefits associated with a central provider of service wherein enterprises can securely connect to access a plurality of wireless and wired networks for carrying multimedia content to a variety of client devices such as remote access terminals and devices. In accordance therewith, the present invention provides a system and method for providing broadband multimedia services via a plurality of client devices through a plurality of access networks, both wired and wireless, to a plurality of enterprises by means of an SPP of the ADI.

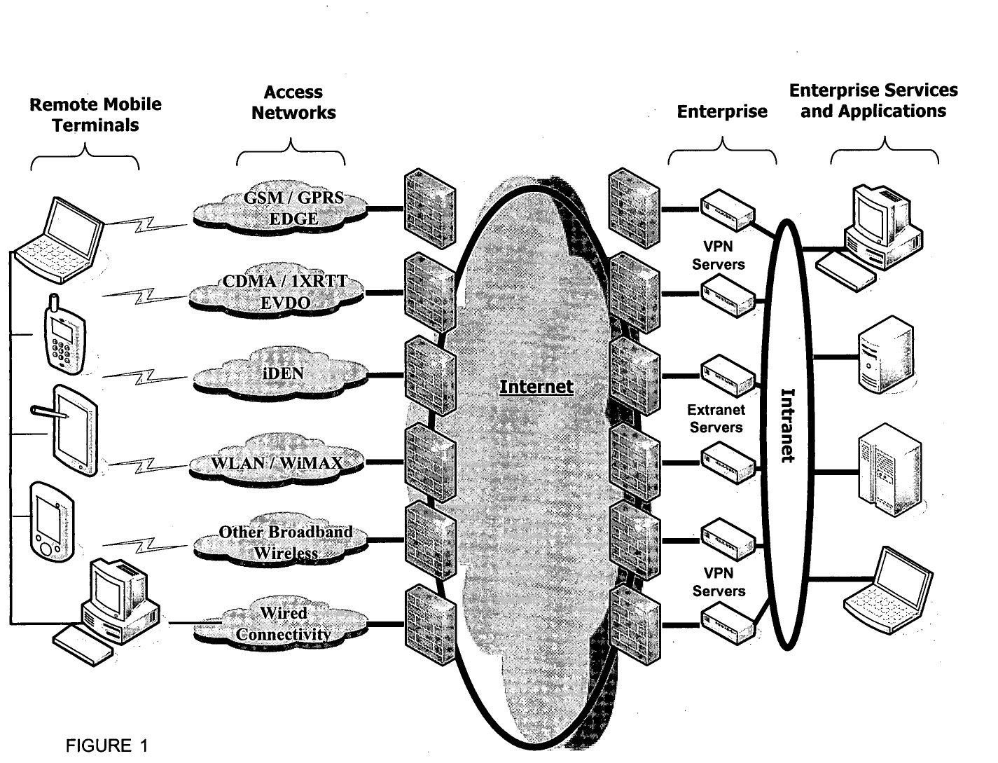

Referring initially to FIG. 1, illustrated is a diagram of an embodiment of an end-to-end network architecture demonstrating remote access to enterprise services and applications [e.g., enterprise resource planning (“ERP”), supply chain management (“SCM”), customer relationship management (“CRM”), e-mail, calendar, PIM] that provide an environment for an application of the principles of the present invention. An overriding need to provide security to protect corporate systems and information forces the enterprise to employ blocking systems to keep unwanted or malicious traffic from entering their network. The individual access network operators have a similar overriding need to protect their networks and systems and they use similar techniques to avoid malicious and harmful intrusion. The connection between the two sets of blocking systems is usually the public Internet over which neither of the end systems have any control to manage quality or performance.

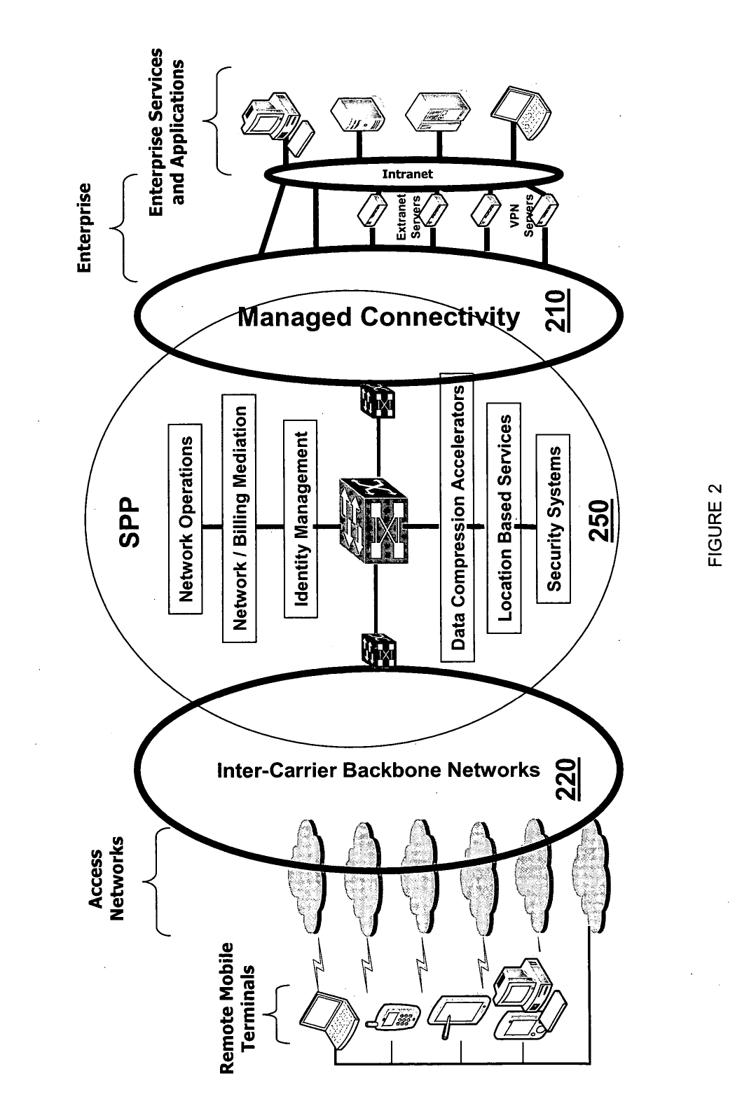

Turning now to FIG. 2, illustrated is a diagram of a high level overview of an embodiment of an end-to-end network architecture with an ADI including an SPP in accordance with the principles of the present invention. The public Internet is replaced by an SPP 250 and connected to the enterprise networks using managed connectivity 210. The SPP 250 provides, without limitation, a trusted VPN intermediary, service enablement, billing/mediation and network management. This provides security as a trusted peer extension of the enterprise intranet (or extranet). The connections to the diverse access networks are moved to inter-carrier backbone networks 220, which may be specific to each carrier or carrier group. The SPP provides the origination and termination of any security features on behalf of the multiple enterprises. Additional services and features can be enabled at the SPP because the terminal types, user profiles, application profiles, and access network features are known by the SPP as a trusted peer and the “home” location of the client devices such as remote mobile terminals. The SPP 250 can provide, among other things, device and identity management, and performance enhancement and, in return, reduce network costs. The SPP 250 can also simplify operations and improve performance for the enterprise.

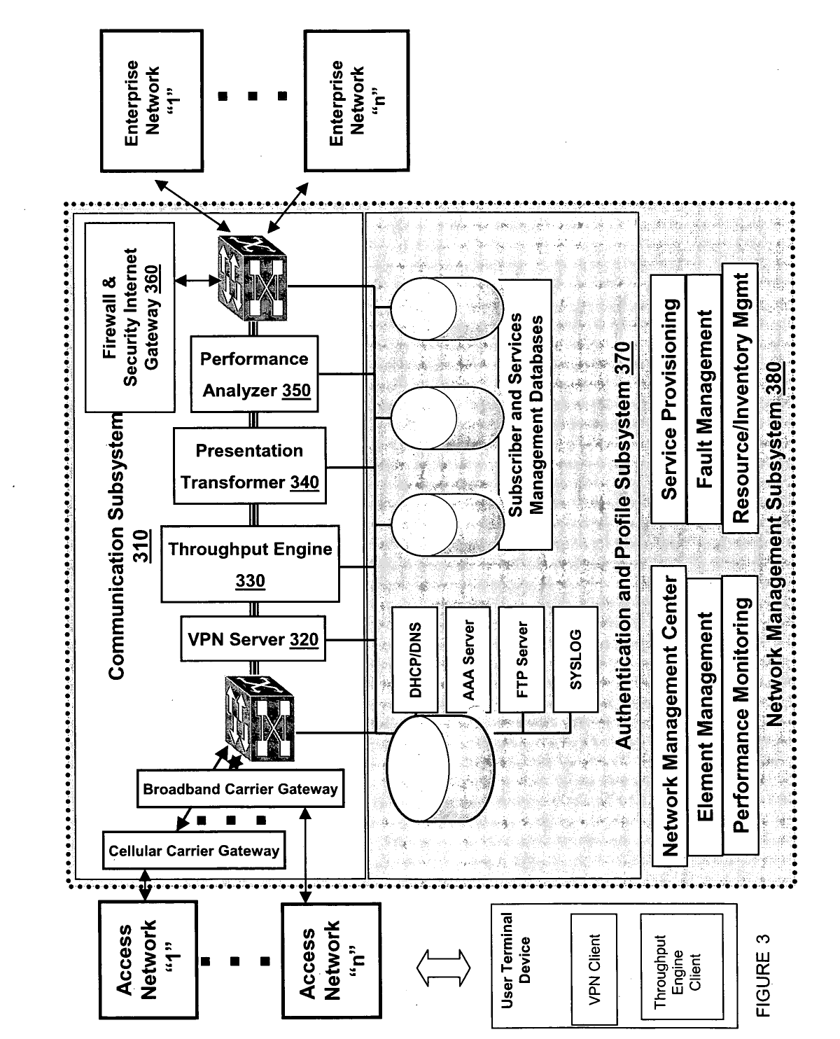

Turning now to FIG. 3, illustrated is a diagram of an embodiment of an SPP constructed in accordance with the principles of the present invention. In the illustrated embodiment, the SPP is connected to the plurality of access networks (referred to as Access Network “1” and Access Network “n”) and enterprises (referred to as Enterprise Network “1” and Enterprise Network “n.” The SPP is a “carrier” grade network system including subsystems and a plurality of network elements that support disparate access networks such as voice over packet or other diverse network types. In many respects, the SPP is analogous to the elements used in a state of the art cellular or wireline carrier data service provider center. Unlike a single network carrier or single enterprise, however, an objective of the SPP is to provide a highly secure and consistent interface to a plurality of access networks (e.g., carriers) for a plurality of enterprises. By placing the SPP spatially between the plurality of possible access networks and the enterprises, a transformation of the information packets can be applied on a consistent basis.

A communication subsystem 310 provides the systems and elements that act on information (e.g., embodied in packets) transmitted between a client device (referred to as a user terminal device) and any system in their respective enterprise. The first element which acts on the user's packets is a VPN server 320 which terminates a high level security VPN working in concert with a VPN client on the user's terminal device. Of course, other types of security systems adapted to provide a secure connection between the user terminal device and enterprises are well within the broad scope of the present invention. The secure connection such as a VPN tunnel transmits the user's information in a highly encrypted mode such as advance encryption standard (“AES”) or triple data encryption standard (“3DES”), which provides the privacy and security of the information. It is preferable that this function operate in a uniform manner regardless of the access network and, therefore, it should not be provided separately by each access network. A clientless VPN such as a secure socket layer VPN operates at higher layers in the protocol stack and provides some security for specific applications or to specific server sites. The clientless VPN, however, often does not assure the enterprise and the user terminal device that 100% of all information is encrypted properly and is secure for transmission across any access network type.

Security of corporate information and systems is an important issue and the SPP provides a complete suite of security services via, for instance, the VPN server 320 for access by the user terminal device to applications resident within the enterprise. By centralizing the remote access from multiple access networks and implementing strong policy techniques like two stage authentication (see discussion below) and conveniences like single sign on can be uniformly applied. The techniques and methodology (including algorithms) used to provide security can also be updated and applied quickly.

The second element is a throughput engine 330 that acts, together with a throughput engine client on the user's terminal device, on the protocol and information (e.g., packets) to improve the total throughput performance of the user information across any access network. An example is the known issue of performance of the widely used transmission control protocol/Internet protocol (“TCP/IP”) in wireless networks. Wireless networks often experience fading and other physical abnormalities which causes TCP/IP to drop to the lowest transmit rate. The protocol then uses an established step method for returning to a higher rate slowly even when the issue is resolved quickly. By converting the protocol to one designed for wireless networks, the throughput is improved significantly without losing any reliability. The client on the user's terminal device matches the action on the throughput engine 330 since the conversion is performed on both ends. An additional improvement can be made by removing extraneous bits that are no longer needed in the packet headers and by combining packet fragments into fewer packets that are matched to perform best in the specific network being used. While many carriers add these kinds of performance enhancements to the information carried on their networks, they cannot add this feature if the information has been secured inside a VPN tunnel. In both cases these functions should be performed outside the VPN tunnel and after decryption. It is for this reason that these functions are not performed by the access network such as a carrier network as the client server relationship cannot be duplicated in a plurality of networks and still function properly. The data throughput engine 330, therefore, performs data compression/acceleration and protocol conversion. The data throughput engine 330 may be viewed as a protocol and content inter-network gateway that can deliver transit delay sensitive applications (e.g., multimedia video conferencing or interactive gaming) and facilitate groupware services including video conferencing and file or application sharing.

The third element that acts on user information is a presentation transformer 340. The proliferation of new devices has led to a variety of form factors, presentation formats and user interfaces. This variety creates a significant challenge in how to present the enterprise information in usable ways on any of this variety of devices. The presentation transformer 340 transforms (including content transcoding and caching) any single information set from the enterprise to a usable presentation format for any user terminal device. The knowledge about the user terminal device and their preferences resides in an authentication and profile subsystem 370 and this knowledge along with the performance of the access network can be used to modify the information to match this specific set of conditions dynamically.

While industry standards like wireless access protocol (“WAP”) have been developed to resolve the differences associated with the proliferation of new devices with a variety of form factors, the multimedia content available as source information is not always compatible for display. Many methods have been developed to address this issue in an attempt to automatically retag the source content for presentation in a standard format. Many business applications, however, do not readily lend themselves to these methods. An alternative approach is to use a semantic search engine to analyze the content of the business application databases and generate appropriate meta-tags for display. The semantic evaluation of unstructured data or the semantic evaluation in combination with discrete fields may generate more accurate results. The presentation transformer 340 in cooperation with other subsystems of the SPP may provide the semantic evaluation (or other methodologies) to resolve the presentation dilemma for the user terminal devices.

The fourth element of the communication subsystem 3 1 0 is the performance analyzer 350, which conducts a deep packet analysis to investigate and determine the performance at any given time for any user terminal device across any access network. This analysis can be used in many ways including determination of cumulative user terminal device performance for any given geographic area or specific access network. Data throughput, speed, and retransmissions are examples of information generated by the performance analyzer 350. This information can be used to create reports for an enterprise on the quality of service delivered to any user terminal device or group of user terminal devices across any given access network. In addition, the quality of service information can be used to modify the throughput engine 330 or the presentation transformer 340 in real time.

The fifth element is a firewall and security Internet gateway 360 to interface the SPP to the public Internet. Any given user terminal device can access the Internet through the firewall and security Internet gateway 360 based on a policy set by their respective enterprise. If access is denied under the corporate policy then the user terminal device is not allowed to pass any information to or from their user terminal device to the World Wide Web. The firewall and security Internet gateway 360 can be used to provide assurance that only user terminal devices associated with a specific enterprise can access that enterprise's network. Thus, the firewall and security Internet gateway 360 provides, without limitation, firewalls with red, black and screened networks, application gateways with proxy servers, screening routers, packet filters, back channel sentries, virus and denial of service protection, and spam filtering.

The authentication and profile subsystem 370 provides the systems and elements that validate the identity of the user terminal device and apply the policies of permissible service and network access by the user terminal device as directed by the enterprise. The systems and elements in the authentication and profile subsystem 370 provide information to the subsystems of the communication subsystem 310 to assist in performing their respective tasks. The authentication and profile subsystem 370 can be considered to be analogous to a home location register (“HLR”) in a cellular network or a home subscriber server (“HSS”) in an IP multimedia system (“IMS”) as defined by the 3rd Generation Partnership Project (3GPP) standards organization, which are incorporated herein by reference. An HSS is a combination of a currently existing UMTS/GSM HLR and the needed register functions for IMS. The HSS will provide the following functions:
User identification, numbering and addressing information,
User security information including network access control information for authentication and authorization,
User location information at intersystem level; HSS handles the user registration, and stores inter-system location information, etc., and
The user profile (services and service specific information as defined in 3G TS 23.228 version 2.0.0 IP Multimedia (IM) Subsystem—Stage 2, which is incorporated herein by reference).

These analogous systems (i.e., the HSS) are integral to a specific access network (e.g., a single carrier) and provide the functions necessary for that network and the respective users. The authentication and profile subsystem 370 of the SPP provides the functions for all of the user terminal devices associated with all of the enterprises and the enterprise networks and services regardless of the employed access network. The authentication and policy information for any user terminal device or group of user terminal devices may be controlled remotely by their associated enterprise. The authentication and profile subsystem 370 may cooperate with a network management subsystem 380 (or other subsystems) to provide, without limitation, user profile management, service provisioning, presence management, and location based/location aware services. The network management subsystem 380 may also facilitate, without limitation, electronic numbering management (“ENUM”) over diverse access networks, multimedia over data or other diverse access networks, asynchronous delivery of content (i.e., push services), personal information management (“PIM”) messaging services and synchronization, telemetry services, hosting of back office, productivity, and communications applications (e.g., ERP, CRM and SCM applications, e-mail, instant messaging), and application service provider (“ASP”) services including hosted ASP services.

The following are definitions for some of the exemplary elements and servers in the authentication and profile subsystem 370. Beginning with a DHCP/DNS subsystem, a dynamic host control protocol (“DHCP”) is a utility that enables a server to dynamically assign IP addresses from a predefined list and limit their time of use so that they can be reassigned. Without DHCP, an information technology manager would have to manually enter in all the IP addresses of all the computers on the network. When DHCP is used and a computer logs onto the network, it automatically gets an IP address assigned to it. For the SPP, DHCP provides a mechanism to assure that the user terminal devices are routed properly to the respective enterprise network. A domain name service (“DNS”) is a system that translates uniform resource locators (“URLs”) to IP addresses by accessing a database maintained on a collection of Internet servers. The system works behind the scenes to facilitate surfing the Web with alpha versus numeric addresses. A DNS server converts a name like mywebsite.com to a series of numbers like 107.22.55.26. Every website has its own specific IP address on the Internet. Thus, the SPP via the DHCP/DNS subsystem can provide the aforementioned translation functionality.

The authentication and profile subsystem 370 also includes an AAA server that handles user terminal device requests for access to computer resources and, for an enterprise, provides authentication, authorization, and accounting (“AAA”) services. The AAA server typically interacts with network access and gateway servers and with databases and directories containing user terminal device information. The current standard by which devices or applications communicate with an AAA server is the remote authentication dial-in user service (“RADIUS”). Diameter represents the next generation of authentication, authorization, and accounting controls for network access, preferable for mobile access and advanced services. Diameter is specifically designed to meet the requirements of the IETF and TIA for CDMA2000, 3GPP2, Mobile IPv4 and IPv6 authentication, authorization, and accounting requirements. The AAA server is an exemplary subsystem that provides a portion of the authentication functionality associated with the authentication and profile subsystem.

Generally speaking, authentication is a process of verifying that someone or something is who they say they are before they are granted access to protected resources. Such resources may include software applications, computing facilities, printed data, check printers, or physical access to facilities and materials. Most discussion of authentication concentrates on online authentication, but offline methods of authentication have been around for quite a while. Such offline methods of authentication include checking for valid forms of identification like a driver's license or passport, or having security personnel check and recognize an employee's face before admitting them into a building. Online authentication tools include user identifications and passwords, smart cards, security tokens, and biometrics. Authentication can be based upon what someone has (a smart card, token, or identification card), what he or she knows (a password or personal identification number), what he or she is (a biometric like a fingerprint or voiceprint), or any combination of these. Normally, the more authentication factors in use, the more secure the authentication. Some methods of authentication, such as a simple user identification and password, are not considered particularly strong since they are susceptible to hacking with freely available tools. Resources requiring strong protection generally require strong or multi-factor authentication. For example, access to a sensitive program may be restricted to authorized users who sign on to a single computer terminal in a physically secure area, inside a company's data center, using a token card and password. A distinction can be made between authentication and authorization; the former deals with validating that users are who they say they are, while the latter deals with validating which specific resources the user has permission to access. Logically, authentication precedes authorization (although they may often seem to be combined).

Authorization is the process of giving someone permission to do or have something. In multi-user computer systems, a system administrator defines for the system which users are allowed access to the system and what privileges to use (such as access to which file directories, hours of access, amount of allocated storage space, and so forth). Assuming that someone has logged in to a computer operating system or application, the system or application may want to identify what resources the user can be given during this session. Thus, authorization is sometimes seen as both the preliminary setting up of permissions by a system administrator and the actual checking of the permission values that have been set up when a user is getting access.

File transfer protocol (“FTP”), a standard Internet protocol, is the simplest way to exchange files between computers on the Internet. Like the hypertext transfer protocol (“HTTP”), which transfers displayable Web pages and related files, and the simple mail transfer protocol (“SMTP”), which transfers e-mail, FTP is an application protocol that uses the Internet's TCP/IP protocols. FTP is commonly used to transfer Web page files from their creator to the computer that acts as their server for everyone on the Internet. It's also commonly used to download programs and other files to a computer from other servers. In this instance, the FTP server will allow secure access for an enterprise to update or change their associated users' profiles and policies for the user terminal devices.

A network management subsystem 380 provides the systems and elements that provide full end to end management functions primarily focused on operations support systems (“OSS”). OSS are closely related to business support systems (“BSS”) but they are differentiated in that they focus on the operation of the network and delivery of the services and functions while BSS relate to the back office business functions like billing. One of the key functions managed at the network management subsystem 380 is device management. Device management refers to the systems and subsystems that manage the hardware and software of the user terminal devices as well as tracking the user terminal devices and performing functions such as centrally applying security and other policies. This is performed by the network management subsystem 380 using a combination of systems integral thereto. For example, the inventory records of the devices and software loads are kept in an inventory management subsystem and updates are sent to the device by a service provisioning system.

Another example of functions performed in the network management subsystem 380 is report generation. The information on quality of service generated by the performance analyzer 350 is collected by the performance monitoring systems and can be correlated with data about the user terminal device and enterprise to generate reports relevant to the service level agreements for specific access networks and specific enterprises. Thus, the network management subsystem 380 in cooperation with the performance analyzer 350 can perform, without limitation, packet level evaluation, packet retransmit analysis, billing and mediation, and network monitoring and measurement. The subsystems within the network management subsystem 380 deliver “carrier” grade network management functions by monitoring the level of services on an end to end basis and in an integrated manner.

Thus, the SPP can enhance a throughput for the user traffic by, for instance, compressing the information and performing efficient protocol conversions such as transmission control protocol (“TCP”) tuning for fewer transmissions. The SPP is a primary controlling mechanism for the end-to-end services. While the SPP has been illustrated and described with a multitude of systems and subsystems, those skilled in the art should understand that fewer subsystems or additional subsystems may be employed to perform ADI functionality with an enterprise communication with a client device over disparate access networks. For instance, while in the illustrated embodiment an SPP is comprehended to serve the entire network, a distributed architecture as hereinafter described is well within the broad scope of the present invention.

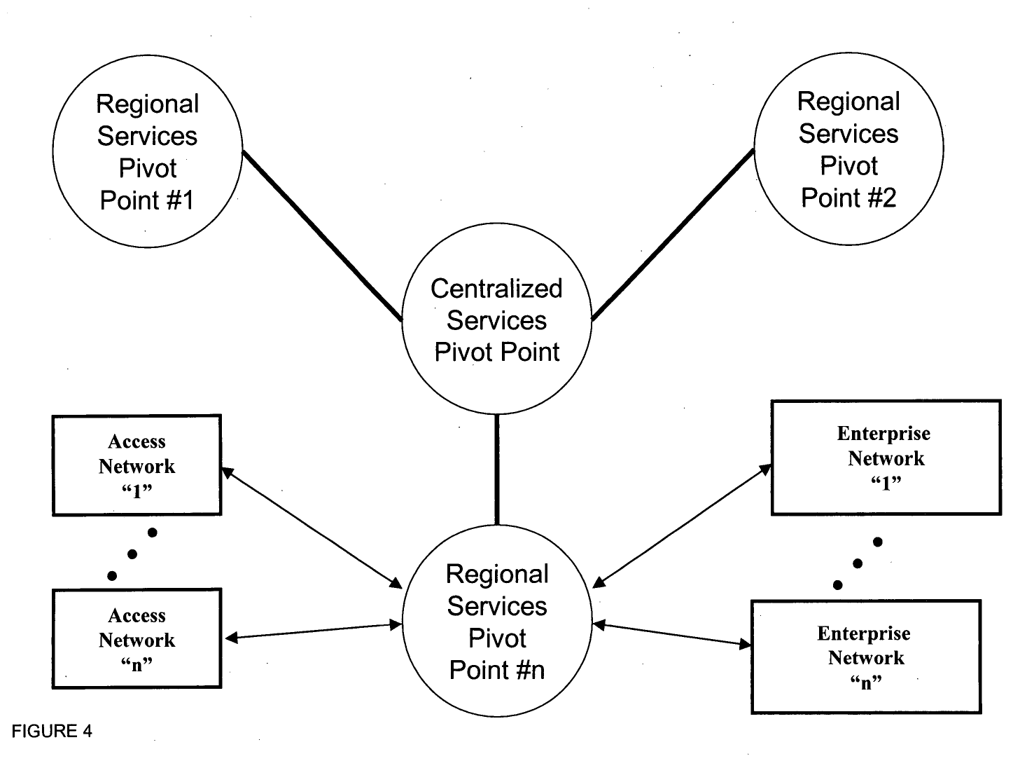

Turning now to FIG. 4, illustrated is a diagram of an embodiment of an SPP employing a distributed architecture in accordance with the principles of the present invention. The SPP architecture is distributed at more than one location as illustrated therein. There are a couple of purposes for deploying regional SPPs. The first is to provide geographic diversity that will improve the performance for any given client device by reducing the potential delay. In addition to improving the performance, the multiple regional SPPs can be used as a back up mechanism to provide enhanced reliability through redundancy. If for any reason a regional SPP fails, the traffic can be routed to a secondary, alternate, regional SPP. Another purpose is closely related to this back up mechanism in the spreading of the traffic load across multiple SPPs as the total load increases in a non-failure mode. It is anticipated that the total volume of traffic will continue to increase dramatically with the availability of improved standards-based wireless protocols. This increase in traffic will result in a matching regionalization or localization of the SPPs to serve the offered traffic load.

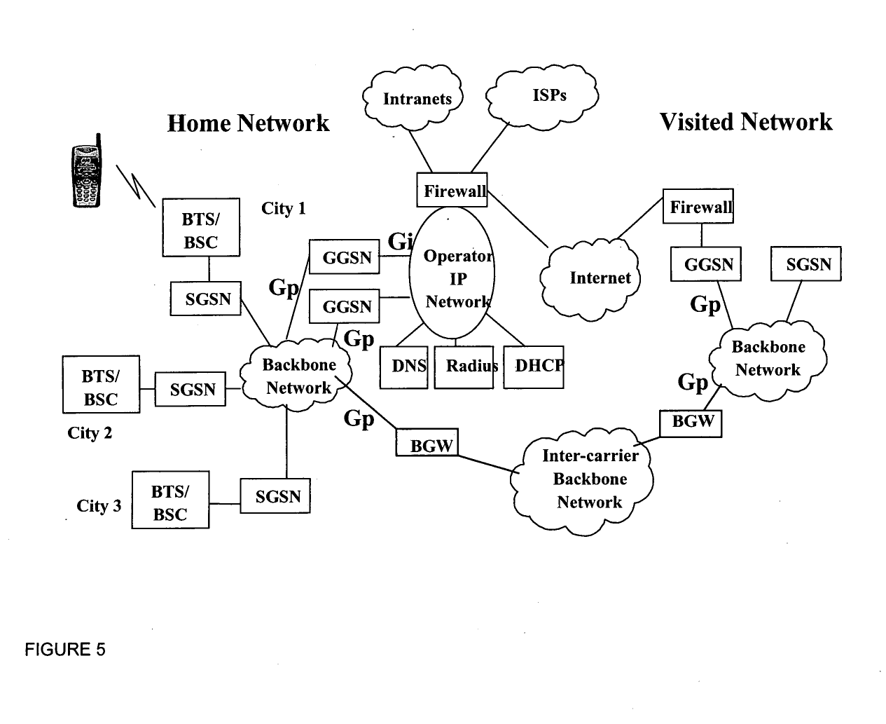

Turning now to FIGS. 5 to 7, illustrated are diagrams of an embodiment of a GPRS roaming architecture, a GPRS transmission plane architecture and a GPRS roaming with the SPP as a home network or a MVNO extension of the enterprise network, respectively, according to the principles of the present invention. As the principles of the present invention interface with access networks such as mobile wireless networks, an embodiment for GPRS as illustrated herein is yet one exemplary embodiment and those skilled in the art will recognize that other access networks such as, but not limited to, EDGE and single carrier [1×] radio transmission technology (“1×RTT”) are comprehended and within the context of this invention.

The complexity of most enterprise applications has led to a great deal of confusion, misunderstanding, and skepticism within information technology departments and among potential users. Many mobile enterprise applications have failed to meet the expectations of the enterprises or the users via the client devices because the applications do not work everywhere and, when the applications are accessible, they tend to be slow and unreliable. With the ADI, however, many of the problems can be overcome. Whether the application is field force automation, fleet management and dispatch, or intranet access for mobile employees, there are three key attributes that are almost uniformly required for success, namely, coverage, security and cost-effectiveness.

These three items are not mutually exclusive. The amount and type of coverage and the performance of the access network within this coverage area will drive the cost thereof and the resulting price of the access service. Also, the way in which the security is provided can significantly impact the cost of the service and the ease of use by the mobile workers. To achieve a balance that provides adequate access network coverage with good throughput and performance, an integrated approach using wireless local area network (“LAN,” such as 802.11x as promulgated by the IEEE, which is incorporated herein by reference) for broadband access in high-density areas and GPRS for medium bandwidth access across a wide coverage area provides a viable solution. While GPRS is a widely available worldwide standard and will be used herein as a reference, most standardized wide area data network services will have similar requirements. Transparent mobility between similar access networks is very complex and this situation becomes far more difficult when mobility between different types of access networks is desired.

Now considering wide area network roaming, an architecture that supports roaming between a home and a visited GPRS access network is shown in FIG. 5. The key interface between these networks is the highlighted Gp interface between the border gateways (“BGW”). The border gateway is a router supporting an exterior routing protocol (e.g., BGP-4) used to do route selection between autonomous systems (“AS”). The border gateway supports inter-working and resolves compatibility issues between different vendors' equipment.

Customer mobile information access to the Internet can be routed through the visited gateway GPRS support node (“GGSN”) directly to the desired Internet service provider (“ISP”) and the visited network collects charging information call detail records (“CDRs”). However, when a mobile enterprise customer using a virtual private network for security roams and experiences a handoff, the session should be maintained through the home network.

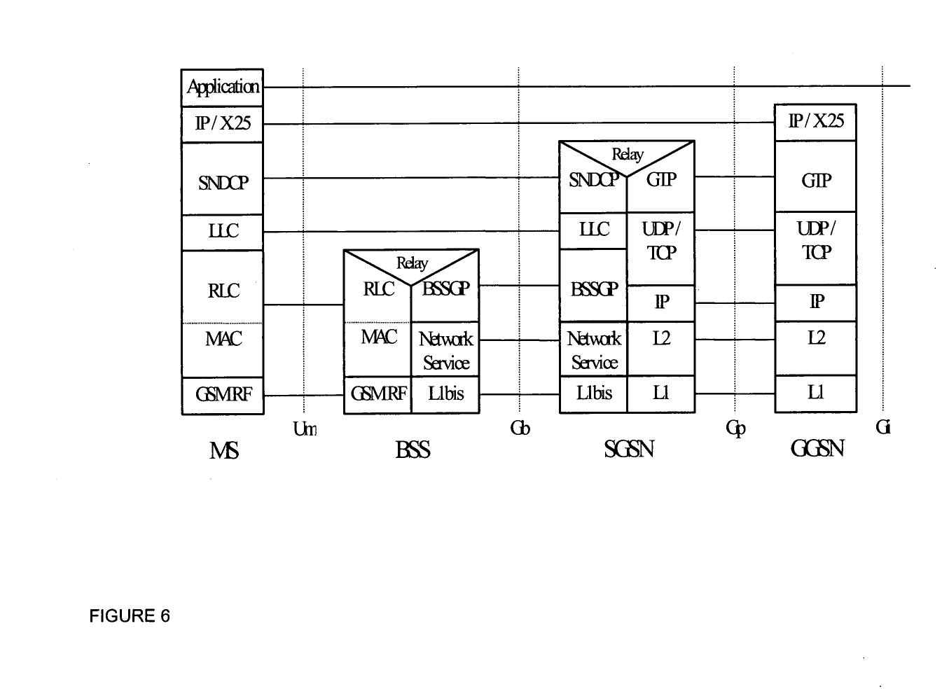

The Gp interface is a multi-layered protocol stack as shown in FIG. 6. Layers 1 and 2 of the Gp interface have not been defined within the standard but have been left up to the operators entering into the roaming agreement to define and agree upon. Layer 3 (the network layer) is IP-based and is currently based on IP version 4 (IPv4). Layer 4 (the transport layer) can be either user datagram protocol (“UDP”) or transmission control protocol (“TCP”) depending on whether best effort transport or a reliable transport is required. With best effort packet transport (UDP), no acknowledgment of packet delivery between the end points of the backbone network would be provided.

With TCP, packets sent over the network are acknowledged and retransmitted in the case of packet errors or loss. This becomes a very important issue in wireless access networks, which exhibit fading and other impairments. TCP was designed to assure performance in a wired network and actually degrades performance in a wide area wireless network. Layer 5 introduces a new protocol developed specifically for GPRS, namely the GPRS Tunneling Protocol (“GTP”).

Tunneling is a mechanism for transporting IP packets between two similar end-points over an interconnecting but dissimilar or disparate access network (e.g., the inter-public land mobile network (“PLMN”) backbone). Tunneling is achieved by encapsulating the packets coming from the TCP/UDP layer into another packet with a new header including an IP address. The original packet becomes the payload for this new combined encapsulated packet structure. In addition to solving the potential incompatibilities between the end networks (GPRS) and the connecting network (inter-PLMN), the tunnel also provides a degree of security since the original data packet is not ‘seen’ by the connecting network.

The GTP is necessary to carry both user information and signaling between the visited and the home networks to support terminal identification and authentication as well as mobility management functions such as GPRS attach or detach and packet data protocol (“PDP”) context activation and deactivation (a data session). The GTP protocol is implemented solely on the serving GPRS support node (“SGSN”) and the GGSN and has no relevance outside of the Gp and the Gn interfaces. The GTP establishes the tunnel on a demand basis between the connecting GSN pair to carry traffic between the nodes.

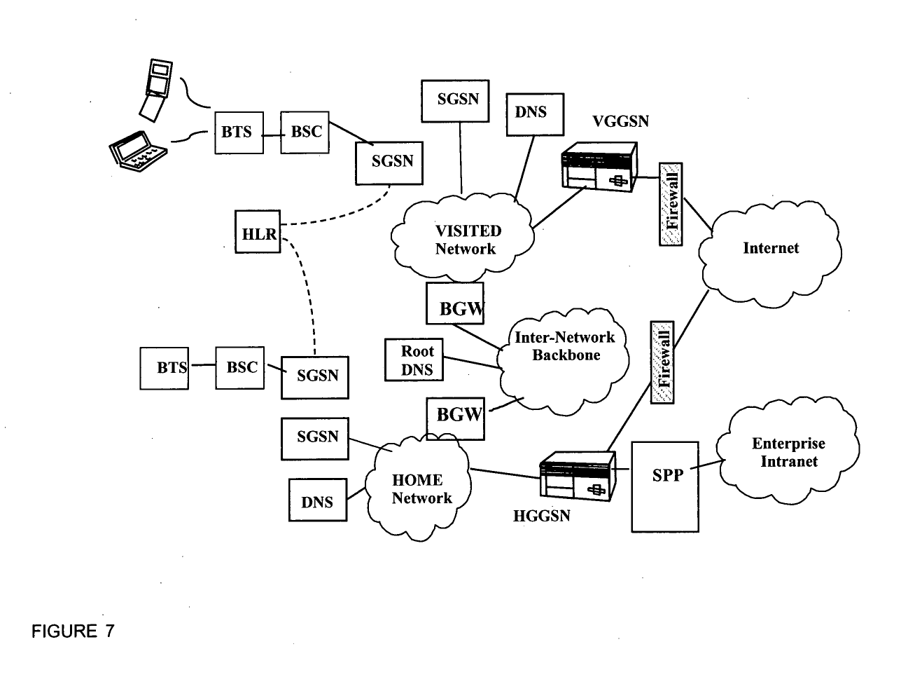

An enterprise customer with a client device such as mobile station running a VPN client on an end-to-end basis would also create a secure tunnel and would most likely use TCP. As discussed above, this can cause significant degradation in performance. To support cost effective and secure access for corporate users, a server providing a pivot/anchor function is a logical solution. For convenience we have named this element the SPP and it is shown in the simplified roaming diagram in FIG. 7. This network element provides a single point of interconnection for an enterprise to reach all of their mobile users via the client devices such as remote access terminals. The SPP is a trusted element, which provides economical concentration and a remote VPN function on behalf of the corporation. To achieve the same level of security, a company would need to have a private facility to every possible network provider, or every user would have to reestablish their VPN on an end-to-end basis every time they moved from one area to another. While the SPP is important for roaming within a single network type, it also offers additional functionality when users roam across different types of access networks.

In summary, the need for an enterprise to deploy mobile applications to improve their competitive position has never been greater. Corporate security and a reasonable expectation of success, however, are the overriding factors for deciding what, when, and how these applications will be deployed. While there have been many attempts to create a viable mobile data market, for the first time we are about to have access networks such as non-proprietary wide area data networks, broadband wireless local area networks, and client devices such as small high performance terminal devices available to support the whole range of possible applications.

The ADI and its SPP interconnects enterprises via the enterprise networks to the multitude of access networks with their diverse performance capabilities. Previous network architectures do not provide adequate visibility or control of the access networks to deliver optimum performance. This architecture can deliver this improved performance and enable a wide range of new services. The network architecture described herein deploys an application delivery intermediary that supports a high degree of mobility for an enterprise or the like. Due to the peer trusted arrangement, the ADI may manipulate the information traffic flowing in either direction therethrough. The manipulation enables the ADI through the SPP to provide a variety of value added managed services to all of the enterprises on a shared basis.

Additionally, exemplary embodiments of the present invention have been illustrated with reference to specific electronic components. Those skilled in the art are aware, however, that components may be substituted (not necessarily with components of the same type) to create desired conditions or accomplish desired results. For instance, multiple components may be substituted for a single component and vice-versa. The principles of the present invention may be applied to a wide variety of network topologies.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A services pivot point for use with first and second enterprises adapted to communicate over disparate access networks, comprising:
a communication subsystem configured to provide a secure connection and data compression/acceleration for a communication between said client device and one of said first and second enterprises over said disparate access networks; and
an authentication and profile subsystem configured to provide said client device access to one of said first and second enterprises over said disparate access networks based on policies associated with said client device.

2. The services pivot point as recited in claim 1 wherein said disparate access networks comprise first and second carriers.

3. The services pivot point as recited in claim 1 wherein said communication subsystem comprises a virtual private network server configured to provide said secure connection for said client device to one of said first and second enterprises over said disparate access networks.

4. The services pivot point as recited in claim 1 wherein said communication subsystem comprises a throughput engine configured to provide protocol conversion and said data compression/acceleration for said communication between said client device and one of said first and second enterprises over said disparate access networks.

5. The services pivot point as recited in claim 1 wherein said communication subsystem comprises a presentation transformer configured to transform content of said communication for presentation to said client device.

6. The services pivot point as recited in claim 1 wherein said communication subsystem comprises a performance analyzer configured to monitor a performance of said communication.

7. The services pivot point as recited in claim 6 wherein said performance analyzer is configured to provide information about said performance to said communication subsystem in real time to enhance said communication between said client device and one of said first and second enterprises over said disparate access networks.

8. The services pivot point as recited in claim 1 further comprising a network management subsystem configured to provide operations services support for client devices communicating with said first and second enterprises.

9. The services pivot point as recited in claim 1 wherein said authentication and profile subsystem is configured to cooperate with a network management subsystem to provide device management for client devices associated with said first and second enterprises.

10. The services pivot point as recited in claim 1 wherein communication subsystem is configured to provide access for said client device to applications resident within one of said first and second enterprises.

11. A method of operating a services pivot point for use with first and second enterprises adapted to communicate over disparate access networks, comprising:
providing a secure connection and data compression/acceleration for a communication between said client device and one of said first and second enterprises over said disparate access networks; and
providing said client device access to one of said first and second enterprises over said disparate access networks based on policies associated with said client device.

12. The method as recited in claim 11 wherein said disparate access networks comprise first and second carriers.

13. The method as recited in claim 11 wherein said providing said secure connection is performed by a virtual private network server.

14. The method as recited in claim 11 further comprising providing protocol conversion for said communication between said client device and one of said first and second enterprises over said disparate access networks.

15. The method as recited in claim 11 further comprising transforming content of said communication for presentation to said client device.

16. The method as recited in claim 11 further comprising monitoring a performance of said communication.

17. The method as recited in claim 16 wherein said monitoring said performance of said communication provides information about said performance in real time to enhance said communication between said client device and one of said first and second enterprises over said disparate access networks.

18. The method as recited in claim 11 further comprising providing operations services support for client devices communicating with said first and second enterprises.

19. The method as recited in claim 11 further comprising providing device management for client devices associated with said first and second enterprises.

20. The method as recited in claim 11 further comprising providing access for said client device to applications resident within one of said first and second enterprises.
